(19) United States
(12) Patent Application Publication
(10) Pub. No.: US 2011/0196082 A1
(43) Pub. Date: Aug. 11, 2011

(54) STORAGE-STABLE AQUEOUS EMULSIONS AND LIQUID BLENDS WITH LOW VISCOSITY AS STABILIZERS

(75) Inventors: Karl-Heinz Hornbach, Bad Bellingen (DE); Roswell Easton King, Pleasantville, NY (US); Arpad Major, Kaisten (CH); Jean-Roch Pauquet, Kaiseraugst (CH); Alex Wegmann, Allschwil (CH); Thomas Wehrle, Laufenburg (DE); Philipp Walter, Lorrach (DE); Andreas Cendra, Basel (CH); Walid Al-akhdar, Oberwil (CH)

(73) Assignee: BASF SE, LUDWIGSHAFEN (DE)

(21) Appl. No.: 13/002,849

(22) PCT Filed: Jun. 23, 2009
(86) PCT No.: PCT/EP2009/057762

§ 371 Date: Apr. 28, 2011

(30) Foreign Application Priority Data
Jul. 11, 2008 (EP) 08160238.5

(51) Int. Cl. C08K 5/103; C09K 15/08; C08L 23/12

(52) U.S. Cl. 524/291; 252/404

(57) ABSTRACT

The invention describes a storage-stable aqueous emulsion comprising a) a compound of the formula (I); wherein n is 4 to 23, b) a surfactant, and c) water, and describes a storage-stable liquid blend with low viscosity, which is not an aqueous emulsion, comprising a) a compound of the formula I d) at least a stabilizer selected from the group consisting of phosphites, phosphonites, aminic antioxidants, hydroxylamines, benzofuran-2-ones, thiosynergists, plasticizers, acid scavengers, lubricants, dispersing aids, sterically hindered amines, UV absorbers and sterically hindered phenols other than the compounds of the formula I according to component a). These emulsions and blends are useful as stabilizers for organic materials.

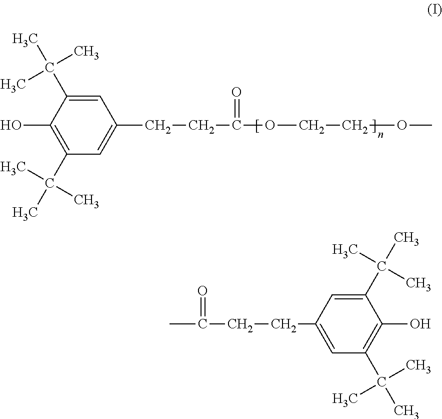

The present invention relates to a storage-stable aqueous emulsion comprising a specific group of liquid phenolic antioxidants and a storage-stable liquid blend with low viscosity comprising a specific group of liquid phenolic antioxidants and at least a stabilizer selected form the group consisting of phosphites, phosphonites, aminic antioxidants, benzofuran-2-ones, thiosynergists and other sterically hindered phenols.

Phenolic antioxidants that are liquid at ambient temperature can give considerable advantages for many applications:

Liquid phenolic antioxidants can be used instead of solid antioxidants in stabilizing polymers in polymerization such as bulk or solution polymerization and in processing such as extrusion, molding, fiber spinning or thermoforming. Of special interest in this respect are polyolefins, engineering polymers such as for example polycarbonates, polyamides, POM, polyethylene terephthalates (PET), polybutylene terephthalates or PMMA; or for example styrenics. Liquid antioxidants enable easy dosing and good dispersibility in the polymer leading to higher efficiency/performance and allowing reduced total system costs at the resin producers/converters. Reasons are lower cost for form giving compared to solid systems, energy saving in the processing and/or reduced investment costs when building new plants. A simpler equipment is sufficient for liquid dosing.

Liquid phenolic antioxidants can be combined with other liquid, or even solid components if these are soluble in the liquid, phenolic antioxidant, to form storage-stable blends that can be added easily to liquid starting materials for polymer manufacturing for example polyols for polyurethanes (PUR) or butadiene for polybutadiene.

Liquid phenolic antioxidants can be used to make storage stable emulsions that can be used for in-situ stabilization of polymers polymerized in emulsion for example ABS, MBS or elastomers; or in suspension for example PVC, PS or SAN.

Liquid low molecular weight phenolic antioxidants show the advantage of low viscosity that enables easy dosing and good dispersibility. The drawback is, however, that they show high volatility and migration. High molecular weight phenolic antioxidants, on the other hand, show low volatility and migration, but high viscosity. High molecular weight phenolic antioxidants can be heated to reduce the viscosity but this requires higher energy and logistical efforts for storage, transportation and dosing. The viscosity can also be reduced by adding co-solvents, but this again has a negative impact on the volatility and can create environmental health security (EHS) issues.

EP 0439427 discloses aqueous emulsions comprising phenolic antioxidants and an antioxidant from the series of thiodipropionic acid esters or organic phosphites, a surfactant based on a carboxylic acid, an alcohol and water.

Surprisingly, it has been found in products based on β-(3,5-di-tert-butyl-4-hydroxyphenyl)-propionic acid methyl ester [Metilox] and polyethylene glycol (PEG) that increasing the molecular weight (MW) by enlarging the MW of the PEG component, the viscosity is not increased but, on the contrary, even significantly reduced. With a molecular weight of PEG above 300, viscosities can be achieved that make for example storage, transport, emulsification or dosing easy. Additionally, the antioxidative performance is higher than expected because of the better dispersibility in the polymer. Even lower viscosity than expected can be achieved by blending the said AOs based on Metilox and PEG with for example liquid phosphites. Preferably, liquid phosphites are based on sec-butylphenols bridged with PEG.

Liquid low viscous phenolic antioxidants based on Metilox and PEG (MW >300) can be used to stabilize organic materials such as for example synthetic polymers after the polymerization and/or during the processing. Compared to solid antioxidants like for example Irganox 1010® or Irganox 1076® or highly viscous liquid antioxidants based on Metilox and PEG (MW <300), less energy is needed to incorporate the products into the polymer melt. The products are better dispersed, leading to a better efficiency and performance. The products can be easily handled, stored, transported, and dosed. Problems in feeding associated with solid products can be avoided. New industrial plants can be equipped with liquid dosing systems that require lower investment costs. Compared to other low viscous liquid antioxidants such as for example Irganox 1520®, Irganox 1135®, CGX AO 145®, styrenated p-cresol, Anox 1315® or Isonox 132® the products according to the present invention show lower volatility (VOC, FOG), less migration (blooming), and better extraction resistance.

Liquid low viscous phenolic antioxidants based on Metilox and PEG (MW >300) can be incorporated into synergistic blends together with other liquid or solid antioxidants or stabilizers. These blends are storage stable at ambient temperature thus forming no solidification or crystallization. The blends are liquid and have a low viscosity that enables easy handling, storage, transport and dosage. These liquid blends can be incorporated in to liquid components of polymers, for example polyols (for PUR) or butadiene for polybutadiene. Due to the low viscosity of the stabilizers the resulting blends show the same advantages regarding handling, storage, transport and dosage. The advantages compared to other low viscous liquid antioxidants are lower volatility (VOC or FOG), less migration (blooming) and better extraction resistance.

The present invention accordingly relates to storage-stable aqueous emulsion comprising
a) a compound of the formula I

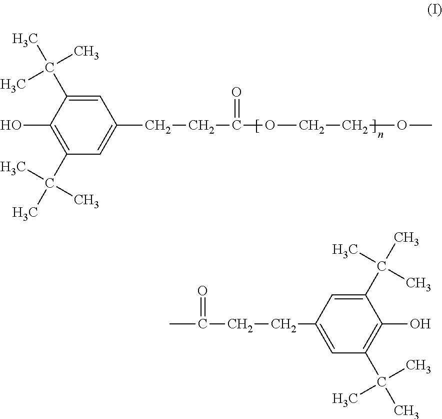

wherein n is 4 to 23;
b) a surfactant; and
c) water;
wherein the content of an alcohol of the formula R′—OH, in which R′ is alkyl having 4 to 19 carbon atoms, alkenyl having 4 to 19 carbon atoms or phenyl-C₄-C₁₉-alkyl, is below 0.25%.

Of interest are storage-stable aqueous emulsions, wherein the content of an alcohol of the formula R′—OH, in which R′ is alkyl having 4 to 19 carbon atoms, alkenyl having 4 to 19 carbon atoms or phenyl-C₄-C₁₉-alkyl, is below 0.20%, preferably below 0.1%, especially preferred below 0.05%. Preferred emulsions are substantially free of an alcohol R′—OH.

Of special interest are storage-stable aqueous emulsions, wherein the content of a monohydric alcohol is below 0.25%, preferably below 0.2%, preferably below 0.1%, especially preferred below 0.1%, very preferably below 0.05%. In particular, they are substantially free of a monohydric alcohol.

A monohydric alcohol is for example one of the formula R″—OH, wherein R″ is alkyl having 1 to 19 carbon atoms, alkenyl having 1 to 19 carbon atoms or phenyl-C₁-C₁₉-alkyl.

Examples for surfactants are polyvinyl alcohol, polyvinyl acetate, a surfactant of the formula R′″—COOY, for example potassium or sodium fatty acid salts, fatty alcohol ethoxylates, for example polyoxyethylene stearylether, polyoxyethylene(20)-sorbitan-monolaurate, fatty alcohol sulphates, for example sodium laurylsulfate, alkylaryl ethoxylates, for example nonylphenol-ethoxylate, or polyalkylene glycols, for example polyethylene glycol.

Preferred surfactants are polyvinyl alcohol, polyvinyl acetate, potassium fatty acid salts, sodium fatty acid salts or polyethylene glycol.

In the formula R′″—COOY, R′″ is alkyl having 1 to 18 carbon atoms, alkenyl having 1 to 18 carbon atoms or phenyl-C₁-C₁₈-alkyl. Y is hydrogen or alkali metal.

Alkali metal is Li, Na, K, Rb or Cs, in particular Na or K.

Preferred is a surfactant of the general formula R′″-COOY, in which R′″ is advantageously C₇-C₁₇—, in particular C₁₁-C₁₇-alkyl, and Y is Na or K.

Preferred is a surfactant of the formula R′″—COOY, which is preferably formed in situ from the carboxylic acid R′″—COOH and a compound of the alkali metal Y, preferably its hydroxide, carbonate or bicarbonate, during preparation of the emulsion.

Surfactants, in which R′″ is C₃-C₁₈alkyl, are for example, the alkali metal salts of butyric acid (butanoic acid), isobutyric acid (2-methylpropanoic acid), valeric acid (pentanoic acid), isovaleric acid (3-methylbutanoic acid), pivalic acid (2,2-dimethylpropanoic acid), lauric acid (dodecanoic acid), myristic acid (tetradecanoic acid), palmitic acid (hexadecanoic acid) and stearic acid (octadecanoic acid).

Preferred salts are those of acids having 8 to 18, in particular 12 to 18, carbon atoms, such as lauric acid, myristic acid, palmitic acid and stearic acid. Particularly preferred salts are those of lauric acid and stearic acid.

The abovementioned acids can also be substituted, advantageously terminally, by a phenyl group.

If R′″ is alkenyl having 3 to 18 carbon atoms, which can be straight-chain or branched, acids which may be mentioned are, for example, methacrylic acid (2-methylpropenoic acid), crotonic acid (trans-2-butenoic acid), isocrotonic acid (cis-2-butenoic acid), oleic acid (cis-9-octadecenoic acid), elaidic acid (trans-9-octadecenoic acid), sorbic acid (trans,trans-2,4-hexadienoic acid), linoleic acid (cis,cis-9,12-octadecadienoic acid) or linolenic acid (cis,cis,cis-9-12,15-octadecatrienoic acid).

Mixtures of the acids mentioned amongst themselves or commercially available acid mixtures, which are known, for example as tall oil, are also suitable.

In compounds of an alkali metal, in particular in an alkali metal hydroxide, alkali metal bicarbonate and alkali metal carbonate (symbol Y), the alkali metal can be Li, Na, K, Rb or Cs. Mixtures of alkali metal hydroxides, alkali metal carbonates and alkali metal bicarbonates are possible. Alkali metal hydroxides and alkali metal carbonates are advantageous, alkali metal hydroxides are preferred and potassium hydroxide is particularly preferred.

A preferred surfactant is polyvinyl alcohol.

Suitable polyvinyl alcohols are obtainable by hydrolysis of polyvinyl acetate and have a mean molar mass of approximately 15 000 to 250 000, which corresponds to a degree of polymerisation of about 500-2 500. Suitable polyvinyl alcohols have a degree of hydrolysis of about 70.0-99.9 mol % and are characterised by their viscosity (of a 4% aqueous solution) according to DIN 53 015 from 2.5 to 60.0 [mPas]. The ester value according to DIN 53 401 decreases from 220 to 8.0 [mg KOH/g] and the residual acetyl content from 17.0 to 0.2% by weight with an increasing degree of hydrolysis.

Suitable polyvinyl alcohols are the commercial products obtainable under the trademark Mowiol®, Clariant GmbH, D-65926 Frankfurt). Special reference is made to the products 3- and 15-96; 3-, 4-, 6-, 10-, 20- and 56-98; or 15- and 28-99 (fully hydrolysed grades). Particularly preferred are the commercial products 15-79; 3-83; 4-, 5-, 8-, 18-, 23-, 26-, 4-, 47- and 56-88; 30-92 (partially hydrolysed grades)

The emulsions according to the invention are preferably brought to a slightly alkaline pH, for example to a pH of 7-9, in particular 7.5-9 and preferably 8-9, for example 8.2-8.8. This can be effected with any desired base, for example with NaOH, KOH, sodium or potassium carbonates or bicarbonates, ammonia or organic amines, in particular with mono-, di- or especially triethanolamine.

Of interest are storage-stable aqueous emulsions where in the compound of the formula I n is 7 to 23.

Of interest are also storage-stable aqueous emulsions comprising besides (a) a compound of formula I, (b) a surfactant and (c) water further additives.

Examples of further additives are compounds selected from the group consisting of phosphites, phosphonites, aminic antioxidants, benzofuran-2-ones, thiosynergists and sterically hindered phenols other than the compounds of the formula I.

Preferably, the storage-stable aqueous emulsion contains possibly other additive, such as antifoams, rheology modifiers or biocides.

The present invention relates also to a storage-stable liquid blend with low viscosity, which is not an aqueous emulsion, comprising
a) a compound of the formula I

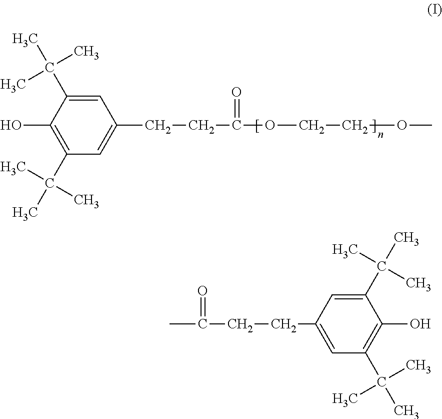

wherein n is 4 to 23, and
d) at least a stabilizer selected from the group consisting of phosphites, phosphonites, aminic antioxidants, hydroxylamines, benzofuran-2-ones, thiosynergists, plasticizers, acid scavengers, lubricants, dispersing aids, sterically hindered amines, UV absorbers and sterically hindered phenols other than the compounds of the formula I according to component a).

Of interest are storage-stable liquid blends with low viscosity wherein the compound of the formula I n is 7 to 23.

Preferably, the blend is liquid at room temperature. Of interest is a blend wherein component d) is also liquid at room temperature.

Storage-stable liquid blends with low viscosity and aqueous emulsions which are of interest include those comprising as component d) or as further additive a compound from the group of the organic phosphites or phosphonites of the formulae 1 to 7

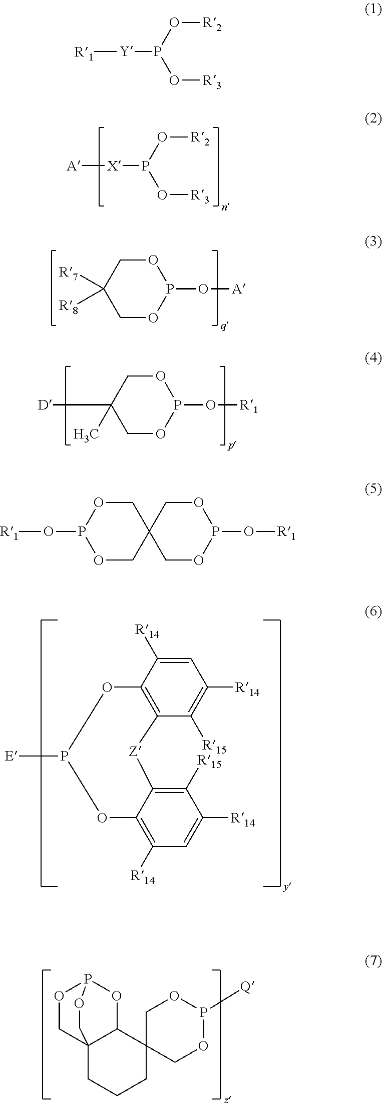

in which the indices are integral and
n′ is 2, 3 or 4; p′ is 1 or 2; q′ is 2 or 3; r′ is 4 to 12; y′ is 1, 2 or 3; and z′ is 1 to 6;
A′, if n′ is 2, is C₂-C₁₂alkylene; C₂-C₁₈alkylene interrupted by oxygen, sulfur or —NR′₄—; a radical of the formula

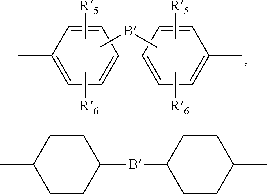

or phenylene;
A′, if n′ is 3, is a radical of the formula —C_{r′}H_{2r′-1}—;
A′, if n′ is 4, is

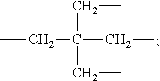

A″ has the meaning of A′ if n′ is 2;
B′ is a direct bond, —CH₂—, —CHR′₄—, —CR′₁R′₄—, sulfur or C₅-C₇cycloalkylidene, or is cyclohexylidene substituted by from 1 to 4 C₁-C₄alkyl radicals in position 3, 4 and/or 5;
D′, if p′ is 1, is methyl and, if p′ is 2, is —CH₂OCH₂—;
E′, if y′ is 1, is C₁-C₁₈alkyl, —OR′₁, or halogen;

### E′, if y is 2, is —O-A″-O—,

E′, if y is 3, is a radical of the formula R′₄C(CH₂O—)₃ or N(CH₂CH₂O—)₃;
Q′ is the radical of an at least z′-valent alcohol or phenol, this radical being attached via the oxygen atom to the phosphorus atom;
R′₁, R′₂ and R′₃ independently of one another are unsubstituted or halogen, —COOR₄′, —CN— or —CONR₄′R₄′-substituted C₁-C₁₈alkyl; C₂-C₁₈alkyl interrupted by oxygen, sulfur or —NR′₄—;
C₇-C₉-phenylalkyl; C₅-C₁₂cycloalkyl, phenyl or naphthyl; naphthyl or phenyl substituted by halogen, 1 to 3 alkyl radicals or alkoxy radicals having in total 1 to 18 carbon atoms or by C₇-C₉-phenylalkyl; or are a radical of the formula

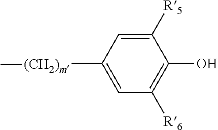

in which m′ is an integer from the range 3 to 6;
R′₄ is hydrogen, C₁-C₁₈alkyl, C₅-C₁₂cycloalkyl or C₇-C₉-phenylalkyl,
R′₅ and R′₆ independently of one another are hydrogen, C₁-C₈alkyl or C₅-C₆cycloalkyl,
R′₇ and R′₈, if q′ is 2, independently of one another are C₁-C₄alkyl or together are a 2,3-dehydropentamethylene radical; and
R′₇ and R′₈, if q′ is 3, are methyl;
R′₁₄ is hydrogen, C₁-C₉alkyl or cyclohexyl,
R′₁₅ is hydrogen or methyl and, if two or more radicals R′₁₄ and R′₁₅ are present, these radicals are identical or different,
X′ and Y′ are each a direct bond or oxygen,
Z′ is a direct bond, methylene, —C(R′₁₆)₂— or sulfur, and
R′₁₆ is C₁-C₈alkyl.

Of particular interest are blends and aqueous emulsions comprising as component d) or further additive a phosphite or phosphonite of the formula 1, 2, 5 or 6, in which

n′ is the number 2 and y′ is the number 1, 2 or 3;
A′ is C₂-C₁₈alkylene or C₂-C₁₂alkylene interrupted by oxygen;
E′, if y′ is 1, is C₁-C₁₈alkyl, —OR′₁ or fluorine;
E′, if y′ is 2, is p-biphenylene,
E′, if y′ is 3, is N(CH₂CH₂O—)₃,
R′₁, R′₂ and R′₃ independently of one another are C₁-C₁₈alkyl, C₇-C₉-phenylalkyl, cyclohexyl, phenyl, or phenyl substituted by 1 to 3 alkyl radicals having in total 1 to 18 carbon atoms;
R′₁₄ is hydrogen or C₁-C₉alkyl,
R′₁₅ is hydrogen or methyl;
X′ is a direct bond,
Y′ is oxygen,
Z′ is a direct bond or —CH(R′₁₆)—, and
R′₁₆ is C₁-C₄alkyl.

Particular preference is given to blends and aqueous emulsions comprising as component d) or as further additive a phosphite of the formula A and formula B

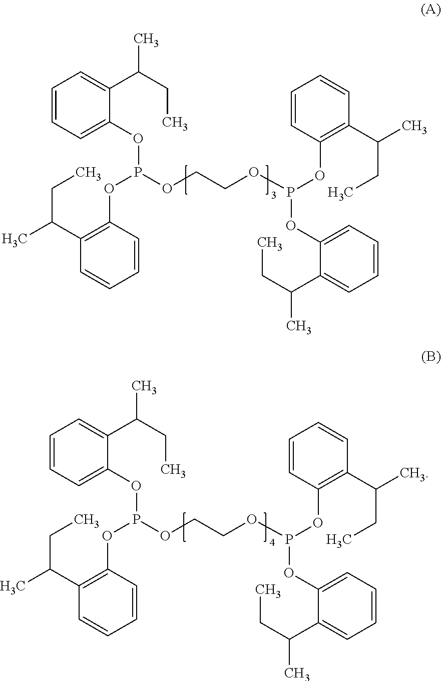

Storage-stable liquid blends with low viscosity and aqueous emulsions which are of interest include those comprising as component d) or as further additive a compound selected from the group consisting of the aminic antioxidants for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

Storage-stable liquid blends with low viscosity and aqueous emulsions which are of interest include those comprising as component d) or as further additive a compound selected from the group consisting of the hydroxylamines for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

Storage-stable liquid blends with low viscosity and aqueous emulsions which are of interest include those comprising as component d) or as further additive a compound selected from the group consisting of the benzofuran-2-ones for example 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one. 3-(2-acetyl-5-isooctyl phenyl)-5-isooctylbenzofuran-2-one is especially preferred.

Storage-stable liquid blends with low viscosity and aqueous emulsions which are of interest include those comprising as component d) or a further additive a compound selected from the group consisting of the thiosynergists for example dilauryl thiodipropionate, dimistryl thiodipropionate, distearyl thiodipropionate or distearyl disulfide.

Storage-stable liquid blends with low viscosity and aqueous emulsions which are of interest include those comprising as component d) or a further additive a compound selected from the group consisting of the plasticizers for example phthalates, adipates, phosphates or trimellitates and also mixtures of synthetic esters with mineral oils in any weight ratios, typically those used as spinning compositions, as well as aqueous emulsions of such materials.

Storage-stable liquid blends with low viscosity and aqueous emulsions which are of interest include those comprising as component d) or as further additive a compound selected from the group consisting of the acid scavengers for example melamine, polyvinylpyrrolidone, dicyandiamide, triallyl cyanurate, urea derivatives, hydrazine derivatives, amines, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

Storage-stable liquid blends with low viscosity and aqueous emulsions which are of interest include those comprising as component d) or as further additive a compound selected from the group consisting of the acid lubricants or for example polyethylene glycol.

Storage-stable liquid blends with low viscosity and aqueous emulsions which are of interest include those comprising as component d) or as further additive a compound selected from the group consisting of the dispersing aids for example 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)-sorbitol, 1,3:2,4-di(paramethyldibenzylidene)sorbitol, and 1,3:2,4-di(benzylidene)sorbitol.

Storage-stable liquid blends with low viscosity and aqueous emulsions which are of interest include those comprising as component (d) or as further additive a compound selected from the group consisting of the sterically hindered amines for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine.

Storage-stable liquid blends with low viscosity and aqueous emulsions which are of interest include those comprising as component d) or as further additive a compound selected from the group consisting of the UV absorbers for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂]₂—, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole; 2-[2′-hydroxy-3′-(1,1,3,3-tetramethylbutyl)-5′-(α,α-dimethylbenzyl)-phenyl]benzotriazole.

Storage-stable liquid blends with low viscosity and aqueous emulsions which are of interest include those comprising as component d) or as further additive a compound selected from the group consisting of the sterically hindered phenols other than the compounds of the formula I for example:

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2, 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.

1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzyl mercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethyl benzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzyl phosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or poly-hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).

1.18. Ascorbic acid (vitamin C).

Preferably, the weight ratio of component (a) to component (d) is from 10: to 1:10, for example 2:1 to 1:4.

Of interest are storage-stable liquid blends with low viscosity comprising in addition, besides components a) and d), further additives, typically the following:

1. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

3. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-di-phenylacrylate.

4. Nickel compounds, for example nickel complexes of 2,2′-thio-bis[4-(1,1,3,3-tetramethyl-butyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

5. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

6. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydrooxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

7. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

8. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-hepta-decylnitrone, N-octadecyl-alpha-hexadecylnitrone, nitrone derived from N,N-dialkylhydroxyl-amine derived from hydrogenated tallow amine.

9. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.

10. Fillers and reinforcing agents, for example calcium carbonate, silicates, glass fibers, glass beads, asbestos, talc, kaolin, mica, barium sulphate, metal oxides and hydroxides, carbon black, graphite, wood flour and flours or fibers of other natural products, synthetic fibers.

11. Other additives, for example plasticisers, lubricants, emulsifiers, pigments, rheology additives, catalysts, flow-control agents, optical brighteners, flame proofing agents, antistatic agents and blowing agents.

Preferred further additives are for example antistatic agents.

The storage-stable liquid blends with low viscosity of components a) and d) and optionally further additives and aqueous emulsions are suitable for stabilizing organic materials against oxidative, thermal or light-induced degradation.

Examples of organic materials are:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerization (normally under high pressure and at elevated temperature).
b) catalytic polymerization using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides or polyolefins.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimides, polyesterimides, polyhydantoins and polybenzimidazoles.

18. Polyesters derived from dicarboxylic acids and diols and/or from hydroxycarboxylic acids or the corresponding lactones or lactides, for example polyethylene terephthalate, polybutylene terephthalate, poly-1,4-dimethylolcyclohexane terephthalate, polyalkylene naphthalate and polyhydroxybenzoates as well as copolyether esters derived from hydroxyl-terminated polyethers, and also polyesters modified with polycarbonates or MBS.

Copolyesters may comprise, for example—but are not limited to—polybutylenesuccinate/terephtalate, polybutyleneadipate/terephthalate, polytetramethyleneadipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lacide and any mixtures thereof.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

31. Aqueous emulsions of natural or synthetic rubber, e.g. natural latex or latices of carboxylated styrene/butadiene copolymers.

An object of the invention is therefore a composition comprising
α) a synthetic polymer which is susceptible to oxidative, thermal or light-induced degradation and selected from the group consisting of styrenic polymers, polyvinyl chlorides, polyoxymethylenes, thermoplastic urethanes and rubbers, and
β) a compound of the formula I;
which is substantially free of an alcohol of the formula R′—OH, in which R′ is alkyl having 4 to 19 carbon atoms, alkenyl having 4 to 19 carbon atoms or phenyl-C₄-C₁₉-alkyl.

Preferred is a composition, which is substantially fee of a monohydric alcohol.

Preferred styrenic polymers are listed above under items 5., 6a., 7. and 19. Examples of especially preferred styrenic polymers are general purpose polystyrene (GPS), impact polystyrene (IPS), acrylonitrile-butadiene-polystyrene (ABS) or styrene-acrylonitrile (SAN) and copolymers thereof.

Preferred polyoxymethylens are listed above under item 13.

Preferred thermoplastic urethanes (TPU) are listed above under item 15.

Examples of rubbers are the following materials

1. Polymers of diolefins, for example polybutadiene or polyisoprene.

2. Copolymers of mono- and diolefins with one another or with other vinyl monomers, e.g. propylene-isobutylene copolymers, propylene-butadiene copolymers, isobutylene-isoprene copolymers, ethylene-alkyl acrylate copolymers, ethylene-alkyl methacrylate copolymers, ethylene-vinyl acetate copolymers, acrylonitrile-butadiene copolymers, and also terpolymers of ethylene with propylene and with a diene, such as hexadiene, dicyclopentadiene or ethylidenenorbornene.

3. Copolymers of styrene or α-methylstyrene with dienes or with acrylic derivatives, e.g. styrene-butadiene, styrene-butadiene-alkyl acrylate and styrene-butadiene-alkyl methacrylate; block copolymers of styrene, e.g. styrene-butadiene-styrene, styrene-isoprene-styrene and styrene-ethylenebutylene-styrene, and also adhesives prepared from the latter three.

4. Halogen-containing polymers, e.g. polychloroprene, chlorinated rubber, chlorinated or brominated copolymer of isobutylene-isoprene (halobutyl rubber), halogenated copolymers of isobutylene and p-methylstyrene.

5. Natural rubber.

Preferably, the rubber component is based on highly unsaturated rubbers such as, for example, natural rubber and/or styrene-butadiene rubber and/or butadiene rubber. Preferably, natural rubbers are used for production of truck tires. Representative of the highly unsaturated polymers that can be employed in the practice of this invention are diene rubbers. Such rubbers will ordinarily possess an iodine number of between about 20 to about 450, although highly unsaturated rubbers having a higher or a lower (e.g. of 50-100) iodine number can also be employed. Illustrative of the diene rubbers that can be utilized are polymers based on conjugated dienes such as, for example, 1,3-butadiene; 2-methyl-1,3-butadiene; 1,3-pentadiene; 2,3-dimethyl-1,3-butadiene; and the like, as well as copolymers of such conjugated dienes with monomers such as, for example styrene, α-methylstyrene, acetylene, e.g. vinyl acetylene, acrylonitrile, methacrylate, methyl acrylate, ethyl acrylate, methyl methacrylate, ethyl methacrylate, vinyl acetate, and the like. Preferred highly unsaturated rubbers include natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, and poly(acrylonitrile-butadiene). Moreover, mixtures of two or more highly unsaturated rubbers with elastomers having lesser unsaturation such as EPDM, EPR, butyl or halogenated butyl rubbers are also within the contemplation of the invention.

6. Aqueous emulsions of natural or synthetic rubbers, e.g. natural rubber latex or latices of carboxylated styrene-butadiene copolymers.

The rubbers of interest are preferably natural or synthetic rubbers or vulcanizates prepared therefrom. Particular preference is given to polydiene vulcanizates, halogen-containing polydiene vulcanizates, polydiene copolymer vulcanizates, in particular styrene-butadiene copolymer vulcanizates, and ethylene-propylene terpolymer vulcanizates.

A further object of the invention is a composition comprising
i) an organic material which is susceptible to oxidative, thermal or light-induced degradation, and
ii) a storage-stable aqueous emulsion comprising
   a) a compound of the formula I,
   b) a surfactant, and
   c) water,
   wherein the content of an alcohol of the formula R′—OH, in which R′ is alkyl having 4 to 19 carbon atoms, alkenyl having 4 to 19 carbon atoms or phenyl-C₄-C₁₉-alkyl, is below 0.25% based on the weight of the emulsion;
   or
   a storage-stable liquid blend with low viscosity, which is not an aqueous emulsion, comprising
   a) a compound of the formula I, and
   d) at least a stabilizer selected from the group consisting of phosphites, phosphonites, aminic antioxidants, hydroxylamines, benzofuran-2-ones, thiosynergists, plasticizers, acid scavengers, lubricants, dispersing aids, sterically hindered amines, UV absorbers and sterically hindered phenols other than the compounds of the formula I according to component a).

To be singled out for special mention is the efficacy of the storage-stable aqueous emulsion or the storage-stable liquid blend with low viscosity against oxidative or thermal degradation, especially under the action of heat which occurs during the processing of thermoplasts. The emulsions and blends of this invention are therefore admirably suited for use as processing stabilizers.

The emulsion and blends of components a) and d) and optionally further additives, for example typically those as outlined above, will preferably be added to the organic material to be stabilized in concentrations of 0.001 to 5%, preferably 0.01 to 5%, typically 0.01 to 1%, based on the weight of said material. In case of aqueous emulsions, the concentrations relates to the weight of the non-aqueous components.

The co-stabilizers are added, for example, in concentrations of from 0.01 to 10%, based on the total weight of the organic materials to be stabilized.

Further preferred compositions also comprise, besides components i) and ii), further additives such as for example antistatic agents.

Also of interest as yet further additives in the compositions according to the invention are alkaline earth metal salts of higher fatty acids or lactic acid, such as, for example, calcium stearate, calcium lactate or calcium stearoyl-2-lactylate.

The terms calcium lactate and calcium stearoyl-2-lactylate are to be understood as meaning those compounds as disclosed in U.S. Pat. No. 4,366,280. A further description of calcium lactate may be found, for example, in The Merck Index, Eleventh Edition, 1683, page 254 (1989). A useful description of calcium stearoyl-2-lactylate may be found, for example, in The Merck Index, Eleventh Edition, 1711, page 257 (1989). These known commercially available compounds are, for example, used also as additives in foodstuffs. They are available from the American Ingredients Company, PATCO Polymer Additives Division, Kansas City, USA, under the following trade names: Pationic 1230® (calcium lactate); Pationic 1240® (mixture of calcium lactate and calcium hydroxide); Pationic 930® (calcium stearoyl-2-lactylate); Pationic 940® (mixture of calcium stearoyl-2-lactylate and calcium hydroxide); Pationic 1250® (mixture of calcium lactate, calcium stearoyl-2-lactylate and calcium hydroxide).

The emulsions or blends and also where applicable further additives, are incorporated into the organic materials according to known methods, for example before or during the shaping. The emulsions or blends and where applicable further additives, may also be added to the organic materials to be stabilized in the form of a masterbatch.

The present invention relates therefore also to a masterbatch composition comprising
a storage-stable emulsion comprising
   a) a compound of the formula I,
   b) a surfactant, and
   c) water,
   wherein the content of an alcohol of the formula R′—OH, in which R′ is alkyl having 4 to 19 carbon atoms, alkenyl having 4 to 19 carbon atoms or phenyl-C₄-C₁₉-alkyl, is below 0.25% based on the weight of the emulsion;
   or
a storage-stable liquid blend with low viscosity, which is not an aqueous emulsion, comprising
   a) a compound of the formula I, and
   d) at least a stabilizer selected from the group consisting of phosphites, phosphonites, aminic antioxidants, hydroxylamines, benzofuran-2-ones, thiosynergists, plasticizers, acid scavengers, lubricants, dispersing aids, sterically hindered amines, UV absorbers and sterically hindered phenols other than the compounds of the formula I according to component a)
      and an organic material and optionally further additives as outlined above.

Preferably, the masterbatch composition comprises 10 to 80% by weight of said organic material.

The storage-stable emulsion comprising a compound of the formula I or the storage-stable liquid blend with low viscosity comprising components a) and d), and where applicable further additives, may also be added before or during polymerization or before cross linking.

The emulsions and blends according to the invention, and where applicable further additives, may be incorporated into the organic materials to be stabilized in pure form or encapsulated in waxes, oils or polymers.

The emulsions and blends according to the invention, and where applicable further additives, may also be sprayed onto the organic materials to be stabilized. The mixture can be used to dilute other additives (e.g. the above-mentioned conventional additives) or melts thereof, so that it is also possible for the mixture to be sprayed together with those additives onto organic materials to be stabilized. Addition by spraying during the deactivation of the polymerisation catalysts is especially advantageous, it being possible, for example, for the vapour used for the deactivation to be utilised for the spraying.

For example, where polymers are polymerized in the form of beads, it may be advantageous for the emulsions and blends according to the invention, and where applicable other additives, to be applied by spraying.

The organic materials, for example synthetic, stabilized in that manner may be used in an extremely wide variety of forms, e.g. in the form of films, fibers, tapes, moulding compounds or profiles, or as binders for surface-coatings, especially powder coatings, adhesives or cements.

The polymers stabilized in that manner may likewise be used in an extremely wide variety of forms, especially in the form of thick-layer moulded articles that are in lasting contact with extracting media, such as, for example, pipes for liquids or gases, films, fibers, geomembranes, tapes, profiles or tanks.

The polymer compositions according to the present invention can be advantageously used for the preparation of various shaped articles. Examples are:

I-1) Floating devices, marine applications, pontoons, buoys, plastic lumber for decks, piers, boats, kayaks, oars, and beach reinforcements.

I-2) Automotive applications, in particular bumpers, dashboards, battery, rear and front linings, moldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof.

I-3) Road traffic devices, in particular sign postings, posts for road marking, car accessories, warning triangles, medical cases, helmets, tires.

I-4) Devices for plane, railway, motor car (car, motorbike) including furnishings.

I-5) Devices for space applications, in particular rockets and satellites, e.g. re-entry shields.

I-6) Devices for architecture and design, mining applications, acoustic quietized systems, street refuges, and shelters.

II-1) Appliances, cases and coverings in general and electric/electronic devices (personal computer, telephone, portable phone, printer, television-sets, audio and video devices), flower pots, satellite TV bowl, and panel devices.

II-2) Jacketing for other materials such as steel or textiles.

II-3) Devices for the electronic industry, in particular insulation for plugs, especially computer plugs, cases for electric and electronic parts, printed boards, and materials for electronic data storage such as chips, check cards or credit cards.

II-4) Electric appliances, in particular washing machines, tumblers, ovens (microwave oven), dish-washers, mixers, and irons.

II-5) Covers for lights (e.g. street-lights, lamp-shades).

II-6) Applications in wire and cable (semi-conductor, insulation and cable-jacketing).

II-7) Foils for condensers, refrigerators, heating devices, air conditioners, encapsulating of electronics, semi-conductors, coffee machines, and vacuum cleaners.

III-1) Technical articles such as cogwheel (gear), slide fittings, spacers, screws, bolts, handles, and knobs.

III-2) Rotor blades, ventilators and windmill vanes, solar devices, swimming pools, swimming pool covers, pool liners, pond liners, closets, wardrobes, dividing walls, slat walls, folding walls, roofs, shutters (e.g. roller shutters), fittings, connections between pipes, sleeves, and conveyor belts.

III-3) Sanitary articles, in particular shower cubicles, lavatory seats, covers, and sinks.

III-4) Hygienic articles, in particular diapers (babies, adult incontinence), feminine hygiene articles, shower curtains, brushes, mats, tubs, mobile toilets, tooth brushes, and bed pans.

III-5) Pipes (cross-linked or not) for water, waste water and chemicals, pipes for wire and cable protection, pipes for gas, oil and sewage, guttering, down pipes, and drainage systems.

III-6) Profiles of any geometry (window panes) and siding.

III-7) Glass substitutes, in particular extruded plates, glazing for buildings (monolithic, twin or multiwall), aircraft, schools, extruded sheets, window film for architectural glazing, train, transportation, sanitary articles, and greenhouse.

III-8) Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.

III-9) Intake and outlet manifolds.

III-10) Cement-, concrete-, composite-applications and covers, siding and cladding, hand rails, banisters, kitchen work tops, roofing, roofing sheets, tiles, and tarpaulins.

IV-1) Plates (walls and cutting board), trays, artificial grass, astroturf, artificial covering for stadium rings (athletics), artificial floor for stadium rings (athletics), and tapes.

IV-2) Woven fabrics continuous and staple, fibers (carpets/hygienic articles/geotextiles/monofilaments; filters; wipes/curtains (shades)/medical applications), bulk fibers (applications such as gown/protection clothes), nets, ropes, cables, strings, cords, threads, safety seat-belts, clothes, underwear, gloves; boots; rubber boots, intimate apparel, garments, swimwear, sportswear, umbrellas (parasol, sunshade), parachutes, paraglides, sails, “balloon-silk”, camping articles, tents, airbeds, sun beds, bulk bags, and bags.

IV-3) Membranes, insulation, covers and seals for roofs, tunnels, dumps, ponds, dumps, walls roofing membranes, geomembranes, swimming pools, curtains (shades)/sun-shields, awnings, canopies, wallpaper, food packing and wrapping (flexible and solid), medical packaging (flexible & solid), airbags/safety belts, arm- and head rests, carpets, centre console, dashboard, cockpits, door, overhead console module, door trim, headliners, interior lighting, interior mirrors, parcel shelf, rear luggage cover, seats, steering column, steering wheel, textiles, and trunk trim.

V) Films (packaging, dump, laminating, agriculture and horticulture, greenhouse, mulch, tunnel, silage), bale wrap, swimming pools, waste bags, wallpaper, stretch film, raffia, desalination film, batteries, and connectors.

VI-1) Food packing and wrapping (flexible and solid), bottles.

VI-2) Storage systems such as boxes (crates), luggage, chest, household boxes, pallets, shelves, tracks, screw boxes, packs, and cans.

VI-3) Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices, and packing for pharmaceuticals blister.

VII-1) Extrusion coating (photo paper, tetrapack, pipe coating), household articles of any kind (e.g. appliances, thermos bottle/clothes hanger), fastening systems such as plugs, wire and cable clamps, zippers, closures, locks, and snap-closures.

VII-2) Support devices, articles for the leisure time such as sports and fitness devices, gymnastics mats, ski-boots, inline-skates, skis, big foot, athletic surfaces (e.g. tennis grounds); screw tops, tops and stoppers for bottles, and cans.

VII-3) Furniture in general, foamed articles (cushions, impact absorbers), foams, sponges, dish clothes, mats, garden chairs, stadium seats, tables, couches, toys, building kits (boards/figures/balls), playhouses, slides, and play vehicles.

VII-4) Materials for optical and magnetic data storage.

VII-5) Kitchen ware (eating, drinking, cooking, storing).

VII-6) Boxes for CD's, cassettes and video tapes; DVD electronic articles, office supplies of any kind (ball-point pens, stamps and ink-pads, mouse, shelves, tracks), bottles of any volume and content (drinks, detergents, cosmetics including perfumes), and adhesive tapes.

VII-7) Footwear (shoes/shoe-soles), insoles, spats, adhesives, structural adhesives, food boxes (fruit, vegetables, meat, fish), synthetic paper, labels for bottles, couches, artificial joints (human), printing plates (flexographic), printed circuit boards, and display technologies.

VII-8) Devices of filled polymers (talc, chalk, china clay (kaolin), wollastonite, pigments, carbon black, TiO₂, mica, nanocomposites, dolomite, silicates, glass, asbestos).

Thus, a further embodiment of the present invention relates to a shaped article, in particular a film, pipe, profile, bottle, tank or container, fiber containing a composition as described above.

A film is preferred. The film can be prepared as a blown film cast film or via extrusion coating. Especially preferred is a multilayer film.

A further embodiment of the present invention relates to a molded article containing an emulsion or blend as described above. The molding is in particular effected by injection, blow, compression, roto-molding or slush-molding or extrusion.

The present invention relates also to a process for stabilizing an organic material against oxidative, thermal or light-induced degradation, which comprises incorporating therein or applying thereto
a storage-stable emulsion comprising
   a) a compound of the formula I,
   b) a surfactant, and
   c) water,
   wherein the content of an alcohol of the formula R′—OH, in which R′ is alkyl having 4 to 19 carbon atoms, alkenyl having 4 to 19 carbon atoms or phenyl-C₄-C₁₉-alkyl, is below 0.25%;
   or
a storage-stable liquid blend with low viscosity, which is not an aqueous emulsion, comprising
   a) a compound of the formula I, and
   d) at least a stabilizer selected from the group consisting of phosphites, phosphonites, aminic antioxidants, hydroxylamines, benzofuran-2-ones, thiosynergists, plasticizers, acid scavengers, lubricants, dispersing aids, sterically hindered amines, UV absorbers and sterically hindered phenols other than the compounds of the formula I according to component a)

A preferred embodiment of the present invention is likewise the use of
a storage-stable emulsion comprising
   a) a compound of the formula I,
   b) a surfactant, and
   c) water,
   wherein the content of an alcohol of the formula R′—OH, in which R′ is alkyl having 4 to 19 carbon atoms, alkenyl having 4 to 19 carbon atoms or phenyl-C₄-C₁₉-alkyl, is below 0.25%;
   or
a storage-stable liquid blend with low viscosity, which is not an aqueous emulsion, comprising
   a) a compound of the formula I, and
   d) at least a stabilizer selected from the group consisting of phosphites, phosphonites, aminic antioxidants, hydroxylamines, benzofuran-2-ones, thiosynergists, plasticizers, acid scavengers, lubricants, dispersing aids, sterically hindered amines, UV absorbers and sterically hindered phenols other than the compounds of the formula I according to component a);
      as stabilizer for organic materials against oxidative, thermal or light-induced degradation.

The preferred emulsions and blends for use as stabilizer and the process for stabilizing organic materials are the same as those described for the emulsions, blends and compositions themselves.

The following Examples illustrate the invention further. Parts or percentages relate to weight.

### EXAMPLE 1

### Preparation of Sterically Hindered Phenolic Antioxidants Based on Metilox and PEG

### EXAMPLE 1a (COMPARATIVE EXAMPLE)

### Preparation of Metilox-PEG 200-Diester [IRGANOX 2000®]

To 97.7 g of polyethylene glycol PEG 200 in a 750 ml glass polymerization reactor, equipped with cooling traps, and pre-heated to 80° C., is added 77 g of cyclohexane under stirring at 400 rpm. Within 30 minutes, the temperature is raised to 120° C. The cyclohexane/water mixture is distilled of into the cooling trap. The temperature is decreased to 100° C., and the reactor purged with Argon. Then 339.4 g of molten β-(3,5-di-tert-butyl-4-hydroxyphenyl)-propionic acid methyl ester [Metilox] is added at 95° C. (internal temperature). Afterwards 3.16 g of aluminum catalyst (Manalox 30 A, aluminum-triisopropylate) is injected. The reaction mixture is kept under vacuum (4-280 mbar) at 100-190° C. for 5-6 hours. Afterwards excess metilox is distilled of while stirring at 400 rpm at 210° C. and 0.5 mbar. Then 6.24 g of citric acid (50%) is added at 75° C. The reaction mixture is stirred for 15 minutes at 300 rpm. Additional 130 ml water and, subsequently, 260 ml cyclohexane is added, and the reaction mixture stirred for 30 minutes at 300 rpm. The organic phase is separated from the aqueous phase, and cyclohexane distilled of. The end product is characterized by HPLC and contains less than 1.4% Metilox, and less than 0.5% polyethylene glycol. The viscosity of Metilox-PEG 200-diester at 20° C. is 245,000 mPas (AR-2000N cone/plate rheometer: 40 mm 2° steel cone with Peltier plate, constant 10 Pa shear stress).

### EXAMPLE 1b

### Preparation of Metilox-PEG 400-Diester

Metilox-PEG 400-diester is prepared in analogy to Example 1a by replacing polyethylene glycol PEG 200 with polyethylene glycol PEG 400. The viscosity of Metilox-PEG 400-diester at 20° C. is 17,460 mPas (AR-2000N cone/plate rheometer: 40 mm 2° steel cone with Peltier plate, constant 10 Pa shear stress).

### EXAMPLE 1c

### Preparation of Metilox-PEG 600-Diester

Metilox-PEG 600-diester is prepared in analogy to Example 1a by replacing polyethylene glycol PEG 200 with polyethylene glycol PEG 600. The viscosity of Metilox-PEG 600-diester at 20° C. is 7,349 mPas (AR-2000N cone/plate rheometer: 40 mm 2° steel cone with Peltier plate, constant 10 Pa shear stress).

### EXAMPLE 2

### Processing Stabilization of Polyolefins

3.0 kg of unstabilized polypropylene homopolymer powder [A 10 TB, Polychim Industrie] is dry-blended with 500 or 1000 ppm of Metilox-PEG-diester (additive) according to Examples 1a, 1b and 1c and 500 ppm calcium stearate. This blend is then extruded in a twin-screw extruder of Berstorff® (ZSK 25, L/D=46) at temperatures of at most 230° C. under nitrogen. The extrudate is then cooled by drawing it through a water bath and granulated. This granulate is repeatedly extruded in a single-screw extruder from Göttfert L/D 25 at 260° C. under air. After the 5^{th} extrusion pass, the melt flow index (MFI) is measured (according to ISO 1133). The results are summarized in Table 1. A correlation between the relative decrease in processing stability (increase of MFI) and the relative decrease of the amount of phenol groups (increase of equivalent weight=molecular weight divided by the amount of phenol groups per molecule) is established. It shows that the processing stability does not decrease as fast as the amount of phenol groups, most likely because of the better dispersibility of the hindered phenol antioxidant.

TABLE 1

| | | Equivalent | 1000 ppm | 500 ppm |
|---|---|---|---|---|
| Exam- | | weight | Additive MFI^{c)} | Additive MFI^{c)} |
| ple | Additive | (increase in %) | (increase in %) | (increase in %) |
| 2a^{a)} | Example 1a | 357 | 12.2 | 17.0 |
| 2b^{b)} | Example 1b | 455 (+27%) | 14.5 (+18.9%) | 18.5 (+8.8%) |
| 2c^{b)} | Example 1c | 551 (+54%) | 15.5 (+27.0%) | 21.0 (+23.5%) |

Footnotes see end of Table 4.

### EXAMPLE 3

### Blends of Liquid Metilox-PEG-Diesters and Liquid Diol Bridged Phosphites

The liquid Metilox-PEG-diesters are mixed with liquid diol bridged phosphites. The viscosity is measured with a cone/plate rheometer. The results are summarized in Tables 2 and 3. The viscosity of the blends is lower than could be expected from the viscosity of the individual components and the respective mix ratio.

TABLE 2

| Example | Additive | Viscosity (mPas) at 20° C. | |
|---|---|---|---|
| 3a^{a)} | Example 1a | 245′000 | |
| 3b^{a)} | Example 1b | 17′460 | |
| 3c^{a)} | Example 1c | 7′349 | |
| 3d^{a)} | Phosphite 3EG^{d)} | 1′850 | |
| 3e^{a)} | Phosphite 4EG^{e)} | 272 | |
| 3f^{b)} | Blend of | 50′480 | (calculated) |
| | 1 part of Example 1a and | 3′514 | (measured) |
| | 4 parts of Phosphite 3EG^{d)} | | |
| 3g^{b)} | Blend of | 4′972 | (calculated) |
| | 1 part of Example 1b and | 2′839 | (measured) |
| | 4 parts of Phosphite 3EG^{d)} | | |
| 3h^{b)} | Blend of | 2′950 | (calculated) |
| | 1 part of Example 1c and | 2′479 | (measured) |
| | 4 parts of Phosphite 3EG^{d)} | | |
| 3i^{b)} | Blend of | 122′636 | (calculated) |
| | 1 part of Example 1a and | 3′355 | (measured) |
| | 1 part of Phosphite 4EG^{e)} | | |
| 3j^{b)} | Blend of | 8′866 | (calculated) |
| | 1 part of Example 1b and | 2′812 | (measured) |
| | 1 part of Phosphite 4EG^{e)} | | |
| 3k^{b)} | Blend of | 3′811 | (calculated) |
| | 1 part of Example 1c and | 2′892 | (measured) |
| | 1 part of Phosphite 4EG^{e)} | | |

Footnotes see end of Table 4.

### EXAMPLE 4

### Storage Stability of Emulsions

50 g of a hindered phenol derivative (Example 1a or Example 1b is heated in a 200 ml beaker to 70° C. 4 g of oleic acid is added into the hot antioxidant, and mixed with a high speed disperser (ULTRA-TURRAX®, TP18/2, JANKE&KUNKEL, Germany) for 2 minutes at 14000-15000 rpm. In a separate beaker, deionized water is preheated to 70-80° C. 62.4 g of this deionized water is added continuously and slowly during about 20-40 seconds under stirring at 14000-15000 rpm to the hot melt mixture and mixed at 14000-15000 rpm for another 2 minutes. Then 3.6 g of a KOH solution (20% by weight) is added slowly under stirring at 14000-15000 rpm. Thereafter, the mixture is further diluted by additional 5 g of deionized water. Then the emulsion is cooled to room temperature and discharged into a glass flask.

Emulsions based on Example 1c are prepared as above, however, the compound of Example 1c and the deionized water are not heated but kept at room temperature for the emulsification, and the emulsion is diluted to 24% active content.

The particle size distribution of the emulsions is measured with a MALVERN Mastersizer 2000, reported are D50 and D90 values in microns [D50 means that 50% of the particles are smaller than this size; D90 means that 90% of the particles are smaller than this size]. A lower particle size usually leads to a better physical stability of an emulsion. The physical stability of the emulsions is also estimated visually immediately after the emulsion is prepared, and then again 1.5 hours later. The results are summarized in Table 3.

TABLE 3

| | | Anti- | | | |
|---|---|---|---|---|---|
| | | oxidant | Particle | Physical stability | |
| Exam- | Anti- | content | size | (visual appearance) | |
| ple | oxidant | (%) | (microns) | 0 hours | 1.5 hours |
| 4a^{b)} | Example 1a | 40 | D50: 4.3 μm | OK | Sedi- |
| | | | D90: 10.4 μm | | mentation |
| | | | Bi-modal | | |
| 4b^{b)} | Example 1b | 40 | D50: 0.92 μm | OK | OK |
| | | | D90: 1.33 μm | | |
| | | | Mono-modal | | |
| 4c^{b)} | Example 1c | 24 | D50: 0.31 μm | OK | OK |
| | | | D90: 0.48 μm | | |
| | | | Mono-modal | | |

Footnotes see end of Table 4.

### EXAMPLE 5

### Storage Stability of Liquid Stabilizer Blends for PUR Stabilization

11 g of 3-(2-acetyl-5-isooctylphenyl)-5-isooctylbenzofuran-2-one, 11 g of bis(2,4-di-tert-butyl-6-methylphenyl)ethyl phosphite and 78 g of a compound according to Example 1a, 1b or 1c is added into a 250 ml conical flask. Under a nitrogen blanket, the mixture is heated on a hotplate (90-100° C.) with a magnetic stirrer, until all solid ingredients are completely dissolved. The mixture is then cooled to ambient temperature. The results are summarized in Table 4.

TABLE 4

| | | | Storage | Storage | Storage |
|---|---|---|---|---|---|
| | | Viscosity | stability at | stability at | stability at |
| | Anti- | at 25° C. | +20° C. | +3° C. | −18° C. |
| Example | oxidant | (mPas)^{f)} | for 3 weeks | for 3 weeks | for 1 week |
| 5a^{a)} | Example | 262000 | clear solution | clear solution | solidified |
| | 1a | | | | |
| 5b^{b)} | Example | 21100 | clear solution | clear solution | solidified |
| | 1b | | | | |
| 5c^{b} | Example | 8687 | clear solution | clear solution | clear solution |
| | 1c | | | | |

^{a)}Comparative Example.
^{b)}Example according to the invention.
^{c)}MFI at 230° C., 2.16 kg; measured after the 5^{th} extrusion pass.
^{d)}Phosphite 3EG is a liquid phosphite of the formula A 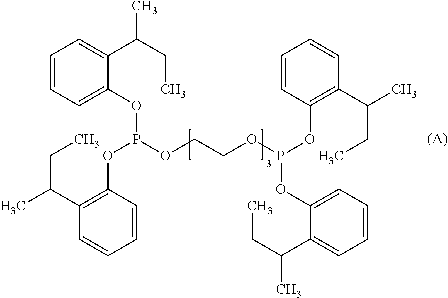
^{e)}Phosphite 4EG is a compound of the formula B 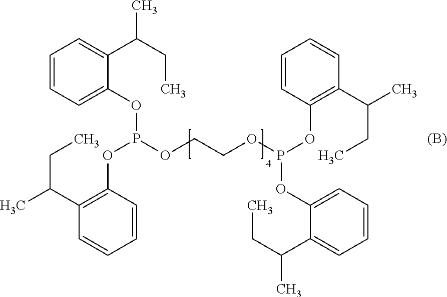
^{f)}HAAKE Viscotester 500 (sensor system 5; procedure NO. 0; speed program NO. 3; offset −0.9° C.).

1. A storage-stable aqueous emulsion comprising
a) a compound of the formula I 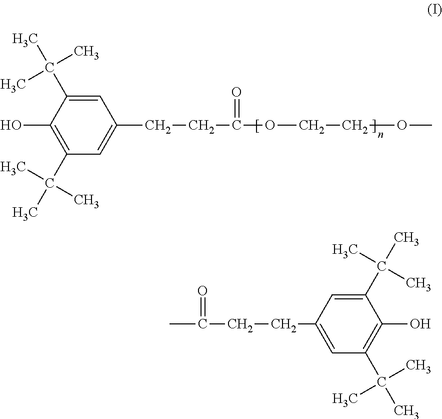
wherein n is 4 to 23;
b) a surfactant; and
c) water;
wherein the content of an alcohol of the formula R′—OH, in which R′ is alkyl having 4 to 19 carbon atoms, alkenyl having 4 to 19 carbon atoms or phenyl-C₄-C₁₉-alkyl, is below 0.25%.

2. A storage-stable aqueous emulsion according to claim 1 comprising besides the compound of the formula I further additives.

3. A storage-stable aqueous emulsion according to claim 2 comprising as further additives compounds selected from the group consisting of phosphites, phosphonites, aminic antioxidants, benzofuran-2-ones, thiosynergists and sterically hindered phenols other than the compounds of the formula I 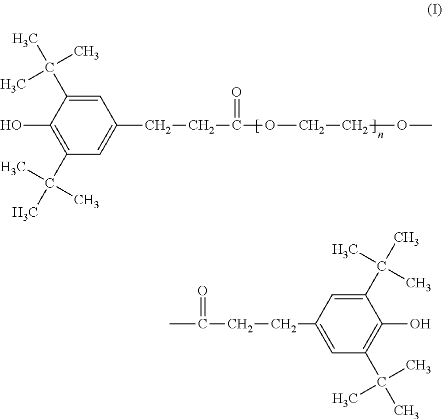
wherein n is 4 to 23.

4. A storage-stable liquid blend with low viscosity, which is not an aqueous emulsion, comprising
a) a compound of the formula I 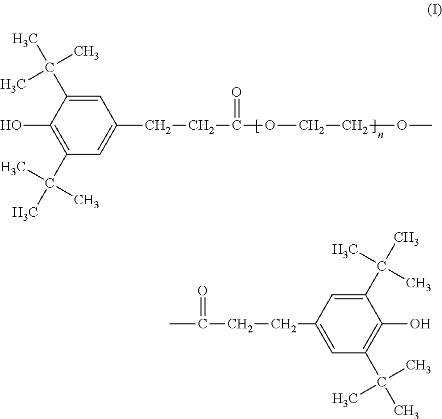
wherein n is 4 to 23, and
d) at least a stabilizer selected from the group consisting of phosphites, phosphonites, aminic antioxidants, hydroxylamines, benzofuran-2-ones, thiosynergists, plasticizers, acid scavengers, lubricants, dispersing aids, sterically hindered amines, UV absorbers and sterically hindered phenols other than the compounds of the formula I according to component a).

5. A blend according to claim 4 which is liquid at room temperature.

6. A blend according to claim 4 wherein component d) is also liquid at room temperature.

7. A blend according to claim 4 comprising besides components a) and d) further additives.

8. A blend according to claim 7 comprising as further additives antistatic agents.

9. A composition comprising
α) a synthetic polymer which is susceptible to oxidative, thermal or light-induced degradation and selected from the group consisting of styrenic polymers, polyvinyl chlorides, polyoxymethylenes, thermoplastic urethanes and rubbers, and
β) a compound of the formula I 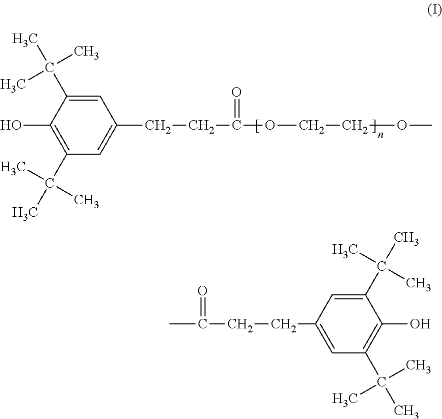
wherein n is 4 to 23;
which is substantially free of an alcohol of the formula R′—OH, in which R′ is alkyl having 4 to 19 carbon atoms, alkenyl having 4 to 19 carbon atoms or phenyl-C₄-C₁₉-alkyl.

10. A composition comprising
i) an organic material which is susceptible to oxidative, thermal or light-induced degradation, and
ii) an aqueous emulsion according to claim 1.

11. A composition according to claim 10, wherein component ii) is present in an amount of from 0.001 to 5%, based on the weight of component i).

12. A composition according to claim 10 comprising besides components i) and ii) further additives.

13. A process for stabilizing an organic material against oxidative, thermal or light-induced degradation, which comprises incorporating therein or applying thereto an aqueous emulsion according to claim 1.

14. A composition comprising
i) an organic material which is susceptible to oxidative, thermal or light-induced degradation, and
ii) a blend according to claim 4.

15. A composition according to claim 14, wherein component ii) is present in an amount of from 0.001 to 5%, based on the weight of component i).

16. A composition according to claim 14 comprising besides components i) and ii) further additives.

17. A process for stabilizing an organic material against oxidative, thermal or light-induced degradation, which comprises incorporating therein or applying thereto a blend according to claim 4.
